(19) United States
(12) Patent Application Publication
(10) Pub. No.: US 2005/0240988 A1
(43) Pub. Date: Oct. 27, 2005

(54) Separate accounting server

(76) Inventor: Jaakko Rajaniemi, HELSINKI (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/518,504

(22) PCT Filed: Jun. 26, 2002
(86) PCT No.: PCT/IB02/02423

§ 371 Date: Dec. 20, 2004

(51) Int. Cl. H04K 1/00

(52) U.S. Cl. 726/4; 726/21; 713/182

(57) ABSTRACT

A method of providing an accounting service in a mobile communication system, comprising the steps of: accessing (M1, M2) a chargeable functionality of said communication system by a user (U), by authenticating said user (U) by a authentication/authorization server (AA-S), and authorizing said access of said user (U) by said authentication/authorization server (AA-S); and indicating (M2) an accounting server (ACC-1) for the user (U) by said authentication/authorization server (AA-S), wherein said accounting server (ACC-1) is physically separated from said authentication/authorization server (AA-S).

### FIELD OF THE INVENTION

The present invention relates to a method of providing an accounting service in a mobile communication system by utilizing a separated accounting server.

### PRIOR ART

Presently considered AAAC (authentication, authorization, accounting and charging) architectures deal with the handling of information required to ensure that a mobile node, mainly a mobile host, is correctly granted access to networking resources in an Internet domain, which it normally does not belong to. In addition, they deal with the data that are collected to provide charging for the service used by the mobile node.

Next to the underlying technology, the business model to be deployed has an impact on the AAAC architecture. This may be the service concept, i.e. which services shall be provided at which quality. However, also charging strategies like pre-paid charging, which gained a lot of subscribers in the GSM market, have different requirements to the AAAC architecture than traditional postpaid charging concepts. Especially the prepaid charging concept rises up timely critical policing requirements which could be both, provider-centric or subscriber-centric. So performance and scaleability issues play an important role on an open and scaleable AAAC architecture supporting various service provisioning concepts. Basically, the AAAC architecture can be regarded from two points of view: the user and the provider perspective. Without discussing it in any detail or explicitly the subscriber perspective is provided by his QoS and mobility requirements. User view's requirements are at some stages of interest, but the complexity of allowing for access and mobility will basically remain similar for the AAAC architecture.

Specifically, FIG. 1 shows a simplified overview of a present AAAC architecture. It consists of AAAC systems which can be either an AAAC server (AAAC-S) or an AAAC client (AAAC-C). The protocol to be operated between the AAAC server and the AAAC client is termed AAA protocol, which may be an enhanced version of either RADIUS ( ) Remote Authentication Dial-In User Service) or DIAMETER (the follow-up to Radius). An AAAC client has no services to offer, however, instead it can request services using the agent authorization model. An AAAC server operates an interface to several application-specific modules (ASM), which provide a service or a functionality (e.g., interface to Mobile IP, Quality-of-Service, content service). The AAAC server also has an interface to external authentication modules to be able to use different authentication techniques.

### SUMMARY OF THE INVENTION

Placed before this background, the present inventor recognized the object of the present invention to provide a method with which an accounting service in a mobile communication system can be performed, when the accounting part is separated from the authentication and authorization nodes.

Accordingly, there is provided a method of providing an accounting service in a mobile communication system, comprising the steps of accessing a chargeable functionality of said communication system by a user, by authenticating said user by a authentication/authorization server, and authorizing said access of said user by said authentication/authorization server; and indicating an accounting server for the user by said authentication/authorization server, wherein said accounting server is physically separated from said authentication/authorization server.

The mentioned chargeable functionality can be a visited network of said mobile communication system or a service of said mobile communication system.

As an implementation of the present invention said accessing step can be performed by sending an authentication/authorization request message from an authentication/authorization client to which said user is currently attached to said authentication/authorization server which replies by sending an authentication/authorization answer message to said authentication/authorization client, and wherein said answer message includes said indication of an accounting server for said user.

In this case, said authentication/authorization server can directly indicate said accounting server to said authentication/authorization client which is handling said user and keeps a corresponding account.

Consequently, there can be a further step of requesting an accounting for said chargeable functionality from said indicated accounting server by said authentication/authorization client.

According to the present invention, it is preferred that, during said accessing step, said authentication/authorization client receives a ticket indicating that said user has been granted to access said chargeable functionality, and said ticket is sent to said accounting server which checks whether accounting for said user is to be started.

In this case, said ticket can contain at least one of the information: to which user it belongs, when the access was granted, for how long the access was granted, and from which client the access was granted.

Moreover, said ticket is preferably signed by the authentication/authorization server so that it is verified to the accounting server that the authentication/authorization server really has made the ticket.

More details as well as advantages of the present invention are apparent from the following detailed description of the preferred embodiments thereof which are to be taken in conjunctions with the appended drawings.

### BRIEF DESCRIPTION OF THE DRAWINGS

FIG. 1 shows a simplified authentication, authorization, accounting and charging architecture as adopted according to the prior art; and

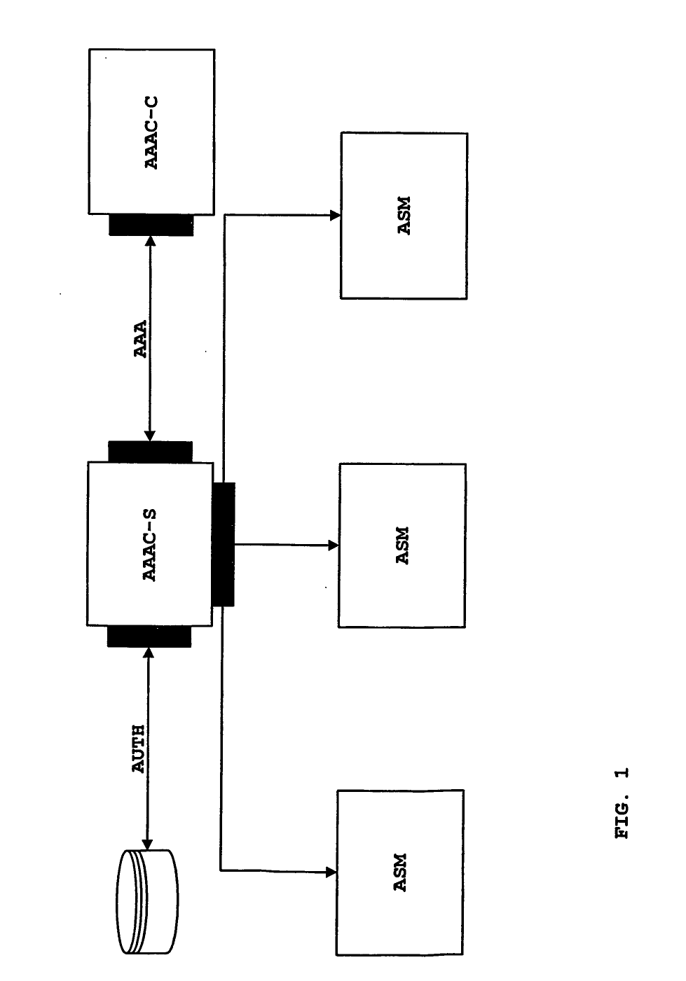

FIG. 2 shows an authentication, authorization, accounting and charging architecture as adopted according to the present invention.

### DESCRIPTION OF THE PREFERRED EMBODIMENTS

The present invention is of a general nature and has been made in view of the 3GPP (3^{rd} generation partnership project) and 3GPP2 systems. In 3GPP, the Diameter protocol, which is the protocol used in the AAA framework, is used in the IMS (IP multimedia subsystem) in the Cx interface which is between the I/S-CSCF (interrogating-/serving-call state control function) and the HSS (home subscriber service) for the AAA purposes. For charging purposes (for simplicity, charging may considered as being roughly the same as accounting), e.g. on-line charging, the Diameter protocol may be used in 3GPP. The charging nodes are separated from the authentication and authorization nodes which are the S-CSCF and the HSS.

When a user accesses a network (or a service, e.g. the session initiation protocol—SIP) the user is authenticated and together with that the network authorizes the access to the network, e.g. based on roaming agreements, etc. For this purpose, the AAA infrastructure can be used.

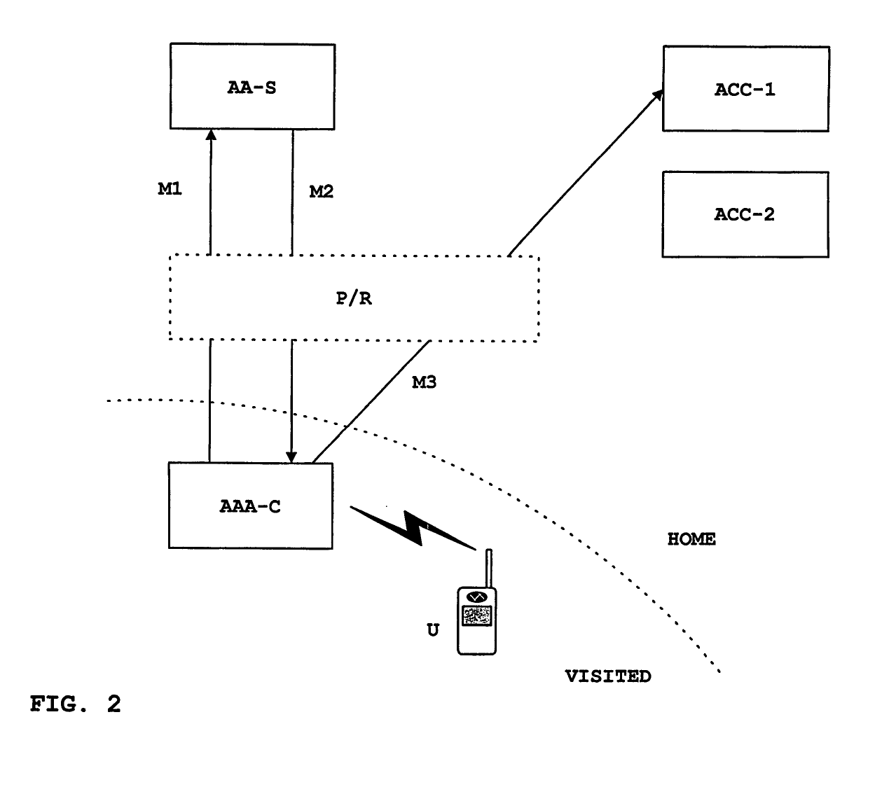

Reference is made to FIG. 2 where an authentication/authorization/accounting client AAA-C within a visited network to which a user U is attached requests the AAA service from the authentication/authorization server AA-S within a home network of the user U (message M1). Once the user U is authenticated and authorized, the authentication/authorization server AA-S grants access to the network (message M2). It is remarked that this may require more than one round-trip between the authentication/authorization/accounting client AAA-C and the authentication/authorization server AA-S.

In the message M2, the authentication/authorization server AA-S may indicate the accounting server ACC-1 for the user U where to send call detailed records (CDR) or which handles on-line charging services (e.g. pre-paid). Currently this is not possible in the Diameter protocol. This has the benefit that the authentication/authorization server AA-S can indicate directly the accounting server ACC-1 (out of several possible ones, indicated by ACC-1, ACC-2) which handles the user U and has the account for him/her.

As a preferred embodiment of the present invention, it is proposed that together with the above the authentication/authorization server AA-S gives a ticket to the authentication/authorization/accounting client AAA-C which needs to be send to the accounting server ACC-1 (message M3) to inform that the user U has been granted to access the network (or service). This ticket may contain information about:
To which user it belongs;
When the access was granted;
For how long the access was granted;
From which authentication/authorization client the access was granted;
Etc.

Preferably, the ticket should be signed by the authentication/authorization server AA-S in order that the accounting server ACC-1 can verify that the authentication/authorization server AA-S really has made the ticket.

Because it is likely that the authentication/authorization server AA-S and the accounting server ACC-1 are in the same domain some of the shared secret mechanisms can be used within the home domain. Also a public key mechanism can be used. The authentication/authorization/accounting client AAA-C only has to pass the ticket to the accounting server ACC-1.

The accounting server ACC-1 uses the ticket to check whether it is okay to start accounting for the user U. If this kind of ticket is not send to the accounting server ACC-1 it does not know whether the user has been really authenticated and/or authorized for access by the (home) authentication/authorization server AA-S. In this case, the accounting server ACC-1 must rely on the authentication/authorization/accounting clients AAA-C. This may have a possible security thread, because there can be many authentication/authorization/accounting clients AAA-C in various places which can be connected to the AAA infrastructure via some brokers. This increases the thread for malicious users to enter the system.

It is remarked that, as indicated in FIG. 2, the messages M1, M2 and M3 can also be sent via a proxy/relay P/R.

As mentioned above, the present invention allows to directly indicate the correct accounting server for the user if it is known in the authentication/authorization server, and the accounting server is provided separately to the authentication/authorization server. This allows to verify if the user was authenticated and authorized in the (home) authentication/authorization server by the separate accounting server.

What is described above is a method of providing an accounting service in a mobile communication system, comprising the steps of: accessing M1, M2 a chargeable functionality of said communication system by a user U, by authenticating said user U by a authentication/authorization server AA-S, and authorizing said access of said user U by said authentication/authorization server AA-S; and indicating M2 an accounting server ACC-1 for the user U by said authentication/authorization server AA-S, wherein said accounting server ACC-1 is physically separated from said authentication/authorization server AA-S.

While it is described above what is presently considered to be the preferred embodiments of the present invention, it is apparent to those skilled in the art that various modifications are possible without departing from the spirit and scope of the present invention.

1-13. (canceled)

14. A method of providing an accounting service in a mobile communication system, comprising the steps of:
accessing a chargeable functionality of said communication system by a user, by authenticating said user by a authentication/authorization server, and
authorizing said access of said user by said authentication/authorization server; and
indicating, by said authentication/authorization server, a specific accounting server out of several possible ones dependent on the user, wherein
said accounting server is physically separated from said authentication/authorization server.

15. A method according to claim 14 wherein said authentication/authorization server is in a home network of said user.

16. A method according to claim 14, wherein said chargeable functionality is a service provided in a visited network of said mobile communication system.

17. A method according to claim 14, wherein said chargeable functionality is a service of said mobile communication system.

18. A method according to claim 14, wherein said accessing step is performed by sending an authentication/authorization request message from an authentication/authorization client to which said user is currently attached to said authentication/authorization server which replies by sending an authentication/authorization answer message to said authentication/authorization client, and wherein said answer message includes said indication of said specific accounting server for said user.

19. A method according to claim 14, wherein said authentication/authorization server directly indicates said specific accounting server to said authentication/authorization client, which specific accounting server is handling said user and keeps a corresponding account.

20. A method according to claim 14, comprising the further step of
requesting an accounting for said chargeable functionality from said indicated accounting server by said authentication/authorization client.

21. A method according to claim 20, wherein, during said accessing step, said authentication/authorization client receives a ticket indicating that said user has been granted to access said chargeable functionality, and said ticket is sent to said accounting server.

22. A method according to claim 21, wherein said accounting server checks whether accounting for said user is to be started.

23. A method according to claim 21, wherein said ticket contains at least one of the information of the group of: to which user it belongs, when the access was granted, for how long the access was granted, and from which client the access was granted.

24. A method according to claim 21, wherein said ticket is signed by the authentication/authorization server so that it is verified to the accounting server that the authentication/authorization server really has made the ticket.

25. A system for providing an accounting service comprising means adapted to perform a method according to claim 14.

26. An accounting server device comprising means adapted to perform respective steps of a method according to claim 14.
